(19) United States
(12) Patent Application Publication
(10) Pub. No.: US 2015/0125372 A1
(43) Pub. Date: May 7, 2015

(54) COMPOSITIONS AND METHODS FOR GAS CAPTURE PROCESSES

(71) Applicants: Ronald C. Stites, Boulder, CO (US); Jerrod Hohman, Louisville, CO (US); Trevor Carlisle, Boulder, CO (US); Andrew L. Lafrate, Boulder, CO (US); Jason E. Bara, Tuscaloosa, AL (US); Gregory Allan Staab, Boulder, CO (US); Michael C. Huffman, Boulder, CO (US)

(72) Inventors: Ronald C. Stites, Boulder, CO (US); Jerrod Hohman, Louisville, CO (US); Trevor Carlisle, Boulder, CO (US); Andrew L. Lafrate, Boulder, CO (US); Jason E. Bara, Tuscaloosa, AL (US); Gregory Allan Staab, Boulder, CO (US); Michael C. Huffman, Boulder, CO (US)

(73) Assignees: ION ENGINEERING, Boulder, CO (US); THE BOARD OF TRUSTEES OF THE UNIVERSITY OF ALABAMA, Tuscaloosa, AL (US)

(21) Appl. No.: 14/117,399

(22) PCT Filed: May 14, 2012
(86) PCT No.: PCT/US2012/037764

§ 371 Date: Jan. 20, 2015

Related U.S. Application Data
(60) Provisional application No. 61/485,864, filed on May 13, 2011.

(51) Int. Cl. B01D 53/14

(52) U.S. Cl. CPC B01D 53/1475; B01D 53/1493; B01D 2252/20484; B01D 2252/604; B01D 2256/22
USPC 423/228; 252/189; 423/210

(57) ABSTRACT

Compositions comprising an organic salt, an amine and water are described herein. The methods of using the compositions include the removal of an acid gas from a gas mixture.

### CROSS-REFERENCE TO PRIORITY APPLICATION

This application claims the benefit of priority to U.S. Provisional Application No. 61/485,864, filed May 13, 2011, which is incorporated herein by reference in its entirety.

### STATEMENT REGARDING FEDERALLY FUNDED RESEARCH

This invention was made with goernment support under grant number DE-FE0005799 awarded by the Department of Energy. The government has certain rights in the invention.

### BACKGROUND

Gas purification is an obligatory step for several industrial processes. Typically, gas purification involves removal of water, carbon dioxide, or other unwanted gases that may interfere with the end use of the purified gas. For example, air must be dried (i.e., water vapor must be removed) before it may be used in machinery such as spray painting equipment, HVAC systems, pneumatic controls, and electronics. Air must also be dried before it is used in the preparation of dry nitrogen. Purified nitrogen, free of both water and oxygen, is used in the storage and shipping of food, as well as in delicate scientific operations such as gas chromatography and mass spectroscopy. Additional industrial gases that need to be purified before use include helium, argon, hydrogen, oxygen, carbon dioxide, and hydrocarbons.

Industrial gases require careful purification before being released into the atmosphere. The most common contaminants present in these industrial gases are carbon dioxide, sulfur dioxide and trioxide, nitrogen oxides, hydrogen sulfide and small organic molecules. Removal of these impurities is important to reduce environmental pollution and minimize potential impacts on global climate.

Development of novel processes for CO₂ capture and sequestration has recently attracted great interest as part of the effort to reduce greenhouse gas emissions. It is estimated that cuts of over 60% in current greenhouse gas emissions, originated mainly from coal or gas-fired gas plants, would be needed to stabilize the atmospheric concentration of CO₂. Removal of additional impurities from flue gas, such as CO, nitrogen oxides, and sulfur oxides, has also been targeted. CO₂ removal from natural gas is useful to increase the energy content per volume of natural gas and to reduce pipeline corrosion. H₂S removal from natural gas is important because this gas is harmful and even lethal. H₂S combustion further leads to the formation of SO₂, another toxic gas and a component leading to acid rain. The most viable method to accomplish this capture (particularly of CO₂) is through chemical absorption, wherein the gas is contacted with a solid or solution containing a chemical agent capable of reacting with and retaining the impurifying gas. Since most impurifying gases in natural gas or power plant flue gas have an acidic character, the chemical agent is often basic in nature, such as an inorganic base, basic salt or organic base.

Amine-based “scrubbing” is used in 95% of U.S. natural gas “sweetening” operations. In this process, CO₂ (and H₂S) react with amines to form an aqueous salt. Traditional CO₂ capture processes use an aqueous solution of ethanolamines to react with and absorb CO₂ from gas streams. In order to reverse the reaction and release the absorbed CO₂ from the amine solution, heat is added to the solution, generally using a reboiled stripper. In addition to the energy required to reverse the reaction, additional energy is required to boil and condense the steam in the regeneration stripper. The process thus involves great energy expenditure, and there is great interest in identifying alternative methods of gas purification that have a lower energy footprint.

Ionic liquids (ILs) have potential to replace the volatile organic solvents used throughout industrial and laboratory settings. ILs are molten salts composed entirely of ionic species, cations and anions, in the absence of a molecular co-solvent. The term “ionic liquid” is commonly used to describe the class of organic salts with relatively low melting points (e.g., below 100° C.). ILs that are liquid at ambient conditions are called room-temperature ionic liquids, or RTILs. RTILs possess obvious advantages over traditional solvents when considering user safety and environmental impact. Under many conditions, ILs have negligible vapor pressures, low flammability, and excellent thermal and chemical stability.

RTILs have been investigated in amine scrubbing processes, for the capture of “acid” gases, such as CO₂, H₂S, and SO₂. In this case, a solution of IL and amine is used. Additionally, the solution may be regenerated by heating the solution and flashing off the CO₂. Since the system contains no water, in principle, the energy requirement of an aqueous system to vaporize water may be avoided. However, use of an IL-amine solution has issues such as high solution viscosity (leading to reduced mass transfer efficiency), and formation of solid carbamates salts in the absorber column (leading to amine loss and operational problems).

One problem observed with amine-IL systems used in acidic gas scrubbing is the degradation of the amine. This degradation reduces CO₂ carrying capacity via loss of reactive amine (a “direct” impact). The degradation products may also react with the remaining amine, resulting in loss of CO₂ carrying capacity (an “indirect” impact). Moreover, higher boiling degradation products tend to build up in the IL and cannot be removed by distillation leading to process issues such as increased viscosity, foaming, and fouling.

Degradation of amines in the presence of CO₂ is a rather complex process. Exemplary amine degradation processes are described in Strazisar et al., “Degradation Pathways for

Monoethanolamine in a CO₂ Capture Facility,” _i Energy and Fuels, 17:1034-1039 (2003) and Lepaumier et al., “Degradation of MMEA at absorber and stripper conditions,” Chemical Engineering Science, 66:3491-3498 (2011), which are incorporated herein by reference in their entireties for their teachings of amine degradation processes. There is a need in the art to identify novel processes for capturing gases. Such processes should be easily implementable in industrial settings, consume less energy than currently used by gas capture processes, and generate fewer unwanted side reactions. The compositions and methods disclosed herein address these and other needs.

### SUMMARY

In accordance with the purposes of the disclosed materials, compounds, compositions, and methods, as embodied and broadly described herein, the disclosed subject matter, in one aspect, relates to compounds and compositions and methods for preparing and using such compounds and compositions. In another aspect, the disclosed subject matter relates to compositions comprising an organic salt, an amine, and water. In a further aspect, the disclosed subject matter relates to methods of using the compositions to remove of an acid gas from a gas mixture. In a still further aspect, the disclosed subject matter relates to adding the organic salt in sufficient quantity to an aqueous solution of amine, used in acidic gas capture, to elevate the boiling point of the water in such a way that the regeneration of the solution can proceed with a lower energy penalty of boiling the water in the solution. In one embodiment, the addition of water to solutions of amine in an organic salt improves the overall properties of the amine-organic salt solution in terms of acidic gas capture. In another embodiment, adding water to the amine-organic salt solution reduces loss of amines. In still another embodiment, adding water to the amine-organic salt solution minimizes or eliminates formation of solid carbamates in the system.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying Figures, which are incorporated in and constitutes a part of this specification, illustrates several aspects described below.

FIG. 1 is a graph illustrating the partial pressure of water over a solution of about 10% water in the organic salt [Emim][EtSO₄]MES. Line 1 depicts the partial pressure as predicted by Raoult's law, which assumes ideal liquid behavior. Solid square points represent experimentally measured values. Line 2 depicts the Aspen process simulation prediction of the partial pressure regressed to fit the experimental data.

FIG. 2 is a photograph depicting tubing from CO₂ absorption testing equipment after using an anhydrous solvent.

FIG. 3 depicts the vapor liquid equilibrium data for two organic salt solvents containing the same cation [Emim] and different anions (ethylsulfate [EtSO₄]) and (triflate (CH₃SO₄) [OT f]).

FIG. 4 contains the ¹H NMR spectra for [Emim][EtSO₄] and MEA (Red: Fresh [Emim][EtSO₄] and MEA; Black: [Emim][EtSO₄] and MEA after aging in the presence of CO₂). Panel A depicts an expansion of aromatic region of NMR spectrum showing imidazolium peaks. Panel B depicts an expansion of alkyl region of NMR showing MEA methylene peaks. Panel C is the full overlaid NMR spectrum.

FIG. 5 contains a picture of vials of organic salt samples (containing MEA and H₂O) aged at 120° C. for 1 week.

FIG. 6 contains stacked ¹H NMR spectra of samples containing [Bmim][Cl], MEA, and H₂O: (a) virgin sample, (b) room-temperature aged sample, and (c) 120° C. aged sample. The spectra are shown in the imidazole/imidazolium region.

FIG. 7 contains ¹H NMR spectra of (a) [Emim][Br] and (b) [Emmim][Br] samples (containing MEA and H₂O) aged at 120° C. The spectra shown highlight the imidazole/imidazolium region.

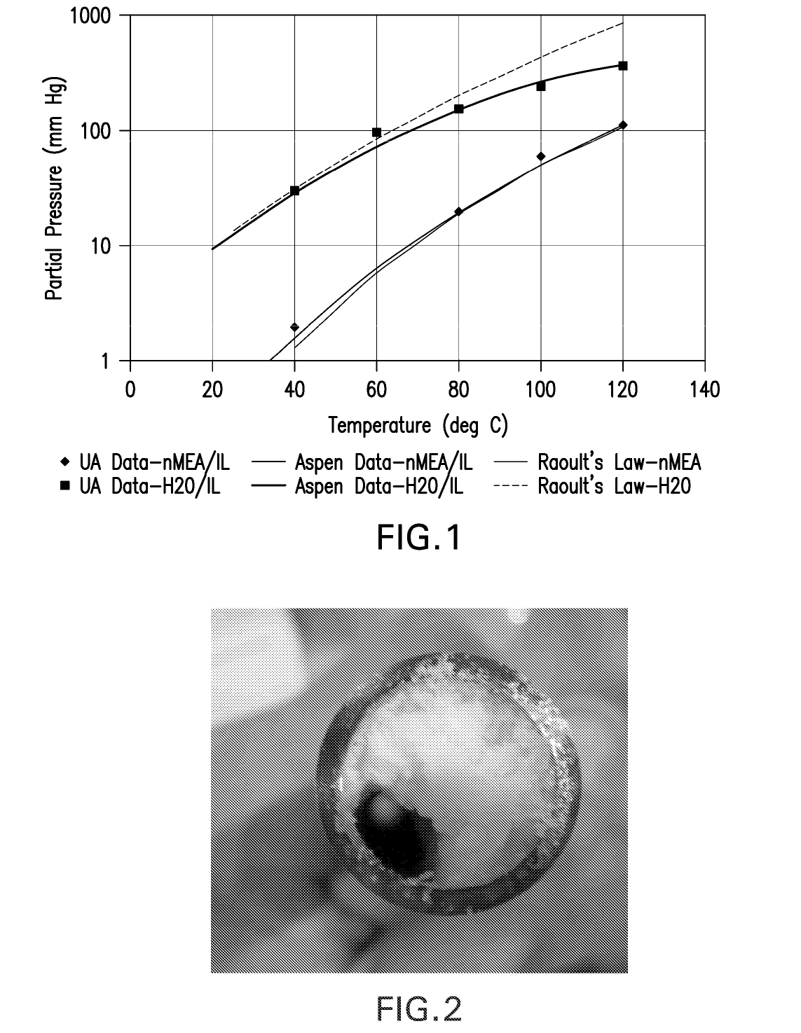

### DETAILED DESCRIPTION

The materials, compounds, compositions, articles, and methods described herein may be understood more readily by reference to the following detailed description of specific aspects of the disclosed subject matter and the examples included therein.

Before the present materials, compounds, compositions, kits, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an organic salt” includes mixtures of two or more such salts, and reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed, then “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

By “reduce” or other forms of the word, such as “reducing” or “reduction,” is meant lowering of an event or characteristic (e.g., volatile compounds in a stream). It is understood that this is typically in relation to some standard or expected value, in other words it is relative, but that it is not always necessary for the standard or relative value to be referred to. For example, “reduces CO₂” means reducing the amount of CO₂ in a stream relative to a standard or a control. As used herein, reduce can include complete removal. In the disclosed method, reduction can refer to a 10%, 20%, 30%, 40%, 50%, 60%, 70%, 80%, 90%, or 100% decrease as compared to the standard or a control. It is understood that the terms “sequester,” “capture,” “remove,” and “separation” are used synonymously with the term “reduce.”

By “treat” or other forms of the word, such as “treated” or “treatment,” is meant to add or mix two or more compounds, compositions, or materials under appropriate conditions to produce a desired product or effect (e.g., to reduce or eliminate a particular characteristic or event such as CO₂ reduction). The terms “contact” and “react” are used synonymously with the term “treat.”

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### Chemical Definitions

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

Unless the context requires otherwise, the terms “impurity,” “undesired material,” and “undesired substance” are used interchangeably herein and refer to a substance within a liquid, gas, or solid, which differs from the desired chemical composition of the material or compound. Impurities are either naturally occurring or added during synthesis of a chemical or commercial product. During production, impurities may be purposely, accidentally, inevitably, or incidentally added into the substance or produced or it may be present from the beginning The terms refer to a substance that is present within a liquid, gas, or solid that one wishes to reduce the amount of or eliminate completely.

As used herein, the term “acid gas” or “acidic gas” refers to any gas that reacts with a base. Some acid gases form an acid when combined with water and some acid gases have an acidic proton (e.g., plc, of less than that of water). Exemplary acid gases include, but are not limited to, carbon dioxide (CO₂), hydrogen sulfide (H₂5), carbonyl sulfide (COS), carbon disulfide (CS₂), sulfur dioxide (SO₂), sulfur trioxide (SO₃), nitrous oxide (N₂O), nitric oxide (NO), dinitrogen trioxide (N₂O₃), nitrogen dioxide (NO₂), dinitrogen tetroxide (N₂O₄), dinitrogen pentoxide (N₂O₅), and the like.

A weight percent (wt. %) of a component, unless specifically stated to the contrary, is based on the total weight of the formulation or composition in which the component is included.

As used herein the term “organic salt” is an ionic compound wherein at least one of the ions in the compound is organic in nature. Thus one or more of the ions, which can be a cation, anion, polycation, polyanion, or zwitterion, is organic. Other ions in the organic salt can be non-organic.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)).

The term “anion” is a type of ion and is included within the meaning of the term “ion.” An “anion” is any molecule, portion of a molecule (e.g., Zwitterion), cluster of molecules, molecular complex, moiety, or atom that contains a net negative charge.

The term “cation” is a type of ion and is included within the meaning of the term “ion.” A “cation” is any molecule, portion of a molecule (e.g., Zwitterion), cluster of molecules, molecular complex, moiety, or atom that contains a net positive charge.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen and oxygen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl (e.g., perfluorinated alkyl) alkoxy, alkenyl, alkynyl, aryl, heteroaryl, aldehyde, amino, carboxylic acid, ester, ether, halide, hydroxy, ketone, nitro, silyl, siloxyl, sulfo-oxo, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “alkoxy” as used herein is an alkyl group bound through a single, terminal ether linkage; that is, an “alkoxy” group can be defined as —OA¹ where A¹ is alkyl as defined above.

The term “alkenyl” as used herein is a hydrocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, siloxyl, sulfo-oxo, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, siloxyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “heteroaryl” is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is included in the term “aryl,” defines a group that contains an aromatic group that does not contain a heteroatom. The aryl and heteroaryl groups can be substituted or unsubstituted. The aryl and heteroaryl groups can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, siloxyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

Examples of heteroaryl groups include pyridyl, pyrazinyl, pyrimidinyl (particularly 1- and 4-pyrimidinyl), pyridazinyl, thienyl, furyl, pyrrolyl (particularly 2-pyrrolyl), imidazolyl, benzimidazoles, thiazolyl, benzthiazole, oxazolyl, benzoxazole, pyrazolyl (particularly 3- and 5-pyrazolyl), isothiazolyl, 1,2,3-triazolyl, 1,2,4-triazolyl, 1,3,4-triazolyl, tetrazolyl, 1,2,3-thiadiazolyl, 1,2,3-oxadiazolyl, 1,3,4-thiadiazolyl and 1,3,4-oxadiazolyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, siloxyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above, and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, siloxyl, sulfo-oxo, sulfonyl, sulfone, sulfoxide, or thiol as described herein.

Examples of non-aromatic heterocycloalkyls and heterocycloakenyls include aziridine, oxirane, thiirane, azetidine, oxetane, thietane, pyrrolidine, pyrroline, imidazoline, pyrazolidine, dioxolane, sulfolane, 2,3-dihydrofuran, 2,5-dihydrofuran, tetrahydrofuran, thiophane, piperidine, 1,2,3,6-tetrahydropyridine, 1,4-dihydropyridine, piperazine, morpholine, thiomorpholine, pyran, 2,3-dihydropyran, tetrahydropyran, 1,4-dioxane, 1,3-dioxane, homopiperazine, homopiperidine, 1,3-dioxepane, 4,7-dihydro-1,3-dioxepin and hexamethyleneoxide. Further examples include indolyl (particularly 3-, 4-, 5-, 6- and 7-indolyl), indolinyl, quinolyl, tetrahydroquinolyl, isoquinolyl (particularly 1- and 5-isoquinolyl), 1,2,3,4-tetrahydroisoquinolyl, cinnolinyl, quinoxalinyl (particularly 2-and 5-quinoxalinyl), quinazolinyl, phthalazinyl, 1,8-naphthyridinyl, 1,4-benzodioxanyl, coumarin, dihydrocoumarin, 1,5-naphthyridinyl, benzofuryl (particularly 3-, 4-, 5-, 6- and 7-benzofuryl), 2,3-dihydrobenzofuryl, 1,2-benzisoxazolyl, benzothienyl (particularly 3-4-5-6- and 7-benzothienyl), benzoxazolyl, benzothiazolyl (particularly 2-benzothiazolyl and 5-benzothiazolyl), purinyl, benzimidazolyl (particularly 2-benzimidazolyl), benztriazolyl, thioxanthinyl, carbazolyl, carbolinyl, acridinyl, pyrrolizidinyl, and quinolizidinyl.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” or “CO” is a short hand notation for C═O.

The term “amino” as used herein is represented by the formula —NA′A², where A¹ and A² can each be substitution group as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” or “carboxyl” group as used herein is represented by the formula —C(O)O⁻.

The term “ester” as used herein is represented by the formula —OC(O)A′ or C(O)OA¹, where A¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula A¹OA², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “ketone” as used herein is represented by the formula A¹C(O)A², where A¹ and A² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” or “halogen” as used herein refers to the fluorine, chlorine, bromine, and iodine.

The term “hydroxyl” as used herein is represented by the formula —OH.

The term “nitro” as used herein is represented by the formula —NO₂.

The term “silyl” as used herein is represented by the formula —SiA¹A²A³, where A¹, A², and A³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

The term “sulfonyl” is used herein to refer to the sulfo-oxo group represented by the formula —S(O)₂A¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “sulfonylamino” or “sulfonamide” as used herein is represented by the formula —S(O)₂NH—.

The term “thiol” as used herein is represented by the formula —SH.

The term “thio” as used herein is represented by the formula —S—.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amine group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

It is to be understood that the compounds provided herein can contain chiral centers. Such chiral centers can be of either the (R-) or (S-) configuration. The compounds provided herein can either be enantiomerically pure, or be diastereomeric or enantiomeric mixtures.

The immidazolium cations and organic salts that comprise them are often abbreviated herein. In the abbreviation [Xmim], mim stands for 3-methylimidazolium. The X refers to the substitution at the 1 position of the imidazolium and can be methyl (shown as C₁ or M), ethyl (shown as E, Et, or C₂), propyl (shown as C₃ or P), butyl (shown as B or C₄), and the like. So as a specific example, [Emim] means 1-ethyl-3-methylimidazolium. In the abbreviation [Xmmim], mmim means 2-methyl-3-methylimidazolium, with X being used as just noted above. So here, as example, [C₄mmim], means 1-butyl-2,3-dimethylimidazolium. Similarly pyrrolidinium cations are abbreviated [XYpyrr], with X and Y being two substituents at the one position of the pyrrolidinium. So [C₄C₂pyrr] would be 1-butyl-1 ethyl-pyrrolidinium.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound can, however, be a mixture of stereoisomers.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

Reference will now be made in detail to specific aspects of the disclosed materials, compounds, compositions, articles, and methods, examples of which are illustrated in the accompanying examples.

### Materials and Methods

Disclosed herein are methods that involve the use of aqueous systems of organic salts and an amine to capture acidic gas. The organic salt elevates the boiling point of the water in the system such that the regeneration of the solution by heating can proceed with a reduced energy penalty of boiling the water in the solution. Elevating the boiling point of water in the system reduces the energy required for vaporization of water during the regeneration of the amine solution. In addition to a decreased energy requirement, the regeneration equipment can be an arrangement of heat exchangers and flash drums rather than the more complicated and costly reboiled stripper column.

In the disclosed methods, enough organic salt is added to the aqueous amine solution to elevate the water boiling point high enough to avoid vaporizing significant quantities of water during regeneration, but not so much that the solution continues to absorb water from the flue gas. Continual water absorption from the flue gas may cause the solution to become in effect too diluted, thereby negating some or all of the advantages derived from the boiling point elevation.

Adding organic salts to an amine aqueous system also results in a solution with substantially lower viscosity than the amine-organic salt solution. The resulting viscosity is approximately similar to that of an aqueous amine solution. As a consequence, mass transfer efficiency of the disclosed systems is similar to that of a traditional aqueous solution.

Typical power plant flue gas contains about 15% volume water after the SO₂ scrubber and particulate baghouse. At near-atmospheric pressure, the partial pressure is about 114 torr. At 40-60° C. it is apparent that even the 10% water solution tends to absorb water from the flue gas.

The regeneration for aqueous amine solutions typically takes place at or near atmospheric pressure, but at an elevated temperature. At 120° C., the partial pressure of water over the 10% solution is only about 360 ton. This partial pressure indicates that even at elevated temperatures where the CO₂ is released from solution, the water tends to remain in the liquid phase. As the water content in the solution is increased, the partial pressure likewise increases and increasing amounts of water vaporizes from the solution at the regeneration temperature. Further, adding as little as 5% water to the amine-organic salt solvent inhibits or negates the formation of solid carbamate crystals in the absorber.

### Amine Degradation

A primary amine, such as monoethanolamine (MEA), undergoes decomposition in an amine-IL scrubbing mixture. However, a secondary amine, such as N-methylmonoethanolamine (NMMEA) was found to be much less susceptible to undergo decomposition. Likewise, metal-catalyzed oxidation of NMMEA was found to be less prevalent than in the case of MEA.

Consistently, use of NMMEA instead of MEA in amine-organic salt systems afforded more reproducible vapor liquid equilibrium (VLE) data, demonstrating that this amine-organic salt combination was more stable. Some degradation is still observed but at a much slower rate than the previously tested MEA-organic salt combinations. In a non-limiting aspect, the amine degradation can involve the organic salt anion or cation.

In a non-limiting aspect and not to be bound by theory, there are several possible solutions to the degradation problem. One possibility is to manage H₂O content. Another possibility is to change the structure of the amine. Hydroxylamines with larger and/or more branched substituents may experience less degradation via these mechanisms. Yet another possibility is to replace the hydroxyl group with a different functional group, such as, but not limited to, a ketone group, an aromatic group, an ionic group, a heterocycle, or a halo aromatic group.

Analysis of the possible decomposition products and potential mechanisms in an organic salt/amine system can involve a wide variety of analytical techniques, such as GC/MS for identifying and quantifying organic amine adducts; water co-distillation and/or Karl Fisher Titration for monitoring water content; wet chemical separation and analysis (titration, colorimetry, NMR, UV-Vis, or ion chromatography) for monitoring ammonia; and ion chromatography for monitoring formate, acetate, glyconate, ammonium, nitrate, nitrite, sulfate and sulfite ions.

### Compositions

Provided herein are compositions including an amine, an organic salt, and water.

### Amine

The compositions described herein include an amine. The amine can be a monoamine, a diamine, a polyamine, a polyethylene amine, an amino acid, a neutral N-heterocycle, a neutral N-heterocyclic-alkyl-amine, or a combination or derivative thereof. For example, the amine can be selected from the group consisting of monoethanolamine, N-methyl-monoethanolamine, diglycolamine, diethanolamine, diisopropanolamine, triethanolamine, methyldiethanolamine, N-methyldiethanolamine, 2-amino-2-methyl-1-propanol, diethylenetriamine, spermidine, triethylenetetramine, spermine, and combinations and derivatives thereof.

The amines described herein can be a monoamine compound represented by Formula I-A:

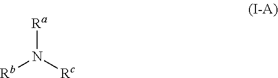

In Formula I-A, R^{a} and R^{b} are each independently selected from hydrogen, alkyl, aryl, aralkyl, cycloalkyl, haloalkyl, heteroalkyl, alkenyl, alkynyl, silyl, and siloxyl.

Also in Formula I-A, R^{c} is hydrogen, alkyl, aryl, aralkyl, cycloalkyl, haloalkyl, heteroalkyl, alkenyl, alkynyl, silyl, siloxyl, or a nitrogen protecting group.

Suitable examples of monoamine compounds as described herein include mono(hydroxyalkyl)amine, di(hydroxyalkyl)amine, tri(hydroxyalkyl)amine, and a combination thereof. In other examples, the monoamine compound can be monoethanolamine, N-methyl-monoethanolamine, N-methyl-diethanolamine, diglycolamine, diethanolamine, diisopropanolamine, triethanolamine, 2-amino-2-methyl-1-propanol, or a combination thereof. In further examples, the monoamine can be tethered to an aryl or heteroaryl by an alkyl chain (e.g., ethyl or propyl). In some examples, the heteroaryl is an imidazole or a pyridine. For example, the amine can be selected from the following Compounds I-1, I-2, I-3, I-4, I-5, or I-6:

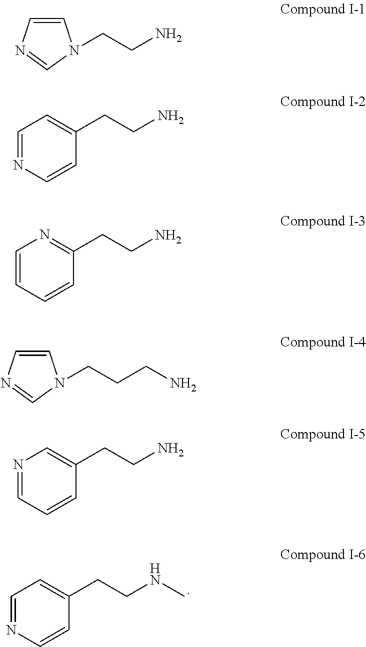

The amines described herein can be a diamine compound represented by Formula I-B:

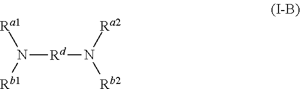

In Formula I-B, R^{a1}, R^{a2}, R^{b1}, and R^{b2} are each independently selected from hydrogen, alkyl, aryl, aralkyl, cycloalkyl, haloalkyl, heteroalkyl, alkenyl, alkynyl, silyl and siloxyl.

Also in Formula I-B, R^{d} is alkylene, aryl, aralkyl, cycloalkyl, halo alkyl, heteroalkyl, alkenyl, alkynyl, silyl or siloxyl.

The amines described herein can be a polyamine represented by Formula I-C:

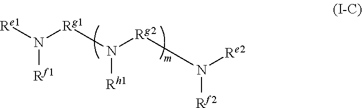

In Formula I-C, R^{e1}, R^{e2}, R^{f1}, R^{f2}, and R^{h1} are each independently selected from hydrogen, alkyl, aryl, aralkyl, cycloalkyl, halo alkyl, heteroalkyl, alkenyl, alkynyl, silyl and siloxyl.

Also in Formula I-C, R^{g1} and R^{g2} are each independently selected from alkylene, arylene, aralkylene, cylcoalkylene, haloalkylene, heteroalkylene, alkenylene, alkynylene, silylene and silo xylene.

Additionally in Formula I-C, m is 1,2,3,4, or 5.

The amines described herein can be a linear poly(ethylene amine) represented by Formula I-D:

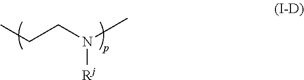

In Formula I-D, each R^{j} is independently selected from hydrogen, alkyl, aryl, aralkyl, cycloalkyl, halo alkyl, heteroalkyl, alkenyl, alkynyl, silyl and siloxyl.

Also in Formula I-D, p is an integer between 1 and 1000.

The amines described herein can be a branched polyethylene amine represented by Formula I-E:

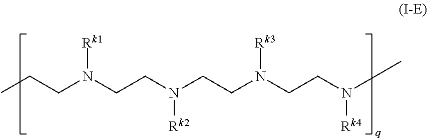

In Formula I-E, R^{k1}, R^{k2}, R^{k3}, and R^{k4} are each independently selected from —R^{m1}—NRⁿ¹Rⁿ², —R^{m1}—NH(R^{m1}—NRⁿ¹Rⁿ²), and —R^{m1}—N(R^{m1}—NR^{a1}Rⁿ²)₂, wjere R^{m1} is alkylene and Rⁿ¹ and Rⁿ² are each independently selected from hydrogen and alkyl.

Also in Formula I-E, q is an integer between 1 and 1000. In some embodiments, the amine described herein can be selected from an amino acid, a neutral N-heterocycle, a neutral N-heterocyclic-alkyl-amine, or a combination of any of the amines described herein.

In other examples, the amine is a heteroalkylamine compound. The heteroalkylamine compound can be, for example, an alkanolamine compound. The alkanolamine compound can comprise a primary hydroxyl group. Typically, the alkanolamine compound comprises a C₂-C₁₀ alkyl chain. For example, the alkanolamine compound can comprise an ethyl group, a propyl group, a butyl group, a pentyl group, a hexyl group, a heptyl group, an octyl group, a nonyl group, or a decyl group. In some embodiments, the alkanolamine compound includes a C₂-C₄ alkyl chain (e.g., an ethyl group, a propyl group, or a butyl group). However, it should be appreciated the length of the alkyl chain is not limited to these specific ranges and examples given herein. The length of the alkyl chain can vary in order to achieve a particular property desired. Optionally, the amine can be diethylenetriamine, spermidine, triethylenetetramine, or spermine.

The amine can be present in the composition in an amount of from about 10% to about 40% by weight of the composition. For example, the amine can be present in the composition in an amount of about 15%, 20%, 25%, 30%, or 35% by weight of the composition, where any of the stated values can form an upper or lower endpoint of a range

### Organic Salt

The disclosed compositions also contain an organic salt, which comprises a cation and an anion. The cation can be, for example, an imidazolium-based organic salt, phosphonium-based organic salt, ammonium-based organic salt, pyridinium-based organic salt, pyrrolidinium-based organic salt, triazolium-based organic salt, piperazinium-based organic salt, sulfonium-based organic salt, oxazolium-based organic salt, thiazolium-based organic salt, thiazolium-based organic salt, tetrazolium-based organic salt, and combinations thereof.

The cation can be selected from Formula II-A:

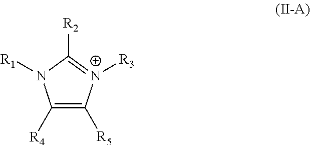

In Formula II-A, R¹ and R³ are each independently selected from hydrogen, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano. In some examples, R³ is alkyl, PEG, or an alkanol. In some examples, R¹, R², and R³ are each substituted or unsubstituted alkyl.

Also in Formula II-A, R², R⁴, and R⁵ are each independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano. In some examples, R² is hydrogen or methyl. In some examples, R⁴ and R⁵ can be selected from hydrogen, methyl, nitro, halogen, cyano, or a fused benzyl group.

Optionally, the compound of Formula II-A can be a 2-subsubstituted imidazolium cation. As used herein, “2-substituted imidazolium” refers to an imidazolium cation substituted in a manner to protect or block the 2-position of the imidazolium cation (i.e., the position occupied by the R² substituent in the Formula II-A structure shown above). In some embodiments, the 2-substituted imidazolium cation is a compound according to Formula II-A where R² is not hydrogen. In other embodiments, the 2-substituted imidazolium cation is a compound according to Formula II-A where R¹ and R³ are not hydrogen. For example, the 2-substituted imidazolium can be Compound II-1 or Compound II-2.

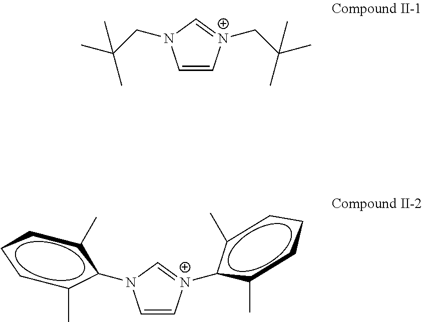

The cation can be selected from Formula II-B:

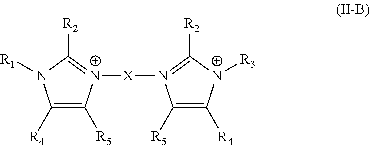

In Formula II-B, each R¹ and R³ are independently selected from hydrogen, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano. In some examples, R³ is alkyl, PEG, or an alkanol.

Also in Formula II-B, each R², R⁴, and R⁵ are independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano. In some examples, R² is hydrogen or methyl.

Additionally in Formula II-B, X is substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, and substituted or unsubstituted aryloxyl. In some examples, X is alkyl, aryl, or PEG.

The cation can be selected from Formula II-C:

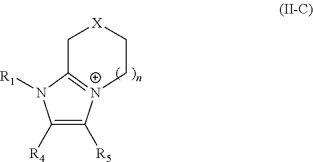

In Formula II-C, R¹ and R³ is hydrogen, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, or cyano.

Also in Formula II-C, R⁴ and R⁵ are each independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano.

Additionally in Formula II-C, X is O, CH₂, or NH.

Further in Formula II-C, n is 1, 2, or 3.

The cation can be selected from Formula II-D:

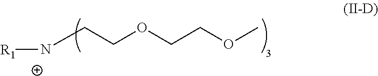

In Formula II-D, R¹ is hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano.

The cation can be selected from Formula II-E:

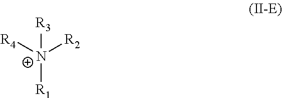

In Formula II-E, R¹, R², R³, and R⁴ are each independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano.

The cation can be selected from Formula II-F:

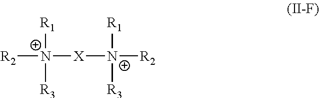

In Formula II-F, each R¹, R², and R³ are independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano.

Additionally in Formula II-F, X is substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, and substituted or unsubstituted aryloxyl. In some examples, X is alkyl, aryl, or PEG.

The cation can be selected from Formula II-G:

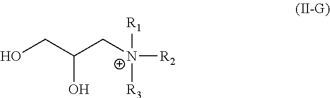

In Formula II-G, R¹, R², and R³ are each independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano.

The cation can be selected from Formula II-H:

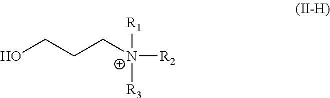

In Formula II-H, R¹, R², and R³ are each independently selected from hydrogen, halogen, hydroxyl, substituted or unsubstituted alkyl, substituted or unsubstituted alkenyl, substituted or unsubstituted alkynyl, substituted or unsubstituted heteroalkyl, substituted or unsubstituted heteroalkenyl, substituted or unsubstituted heteroalkynyl, substituted or unsubstituted cycloalkyl, substituted or unsubstituted hetercycloalkyl, substituted or unsubstituted aryl, substituted or unsubstituted heteroaryl, substituted or unsubstituted thio, substituted or unsubstituted amino, substituted or unsubstituted alkoxyl, substituted or unsubstituted aryloxyl, silyl, siloxyl, and cyano.

In some embodiments, the cation can be one of the following Compounds 11-3 or 11-4.

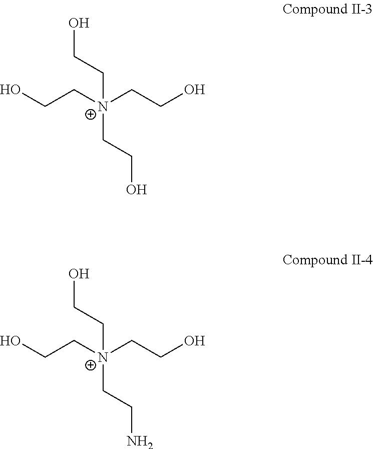 [SMILES: OCC[N+](CCO)(CCO)CCO ; NCC[N+](CCO)(CCO)CCO]

The anion of the organic salt is selected from the group consisting of a substituted or unsubstituted alkyl sulfonate such as MeSO₃, EtSO₃, OTf, tosylate, Tf₂N, and halides (i.e., Cl, Br, I).

In some embodiments, the organic salt includes a halide (e.g., Cl⁻, Br⁻ or I⁻) as the anion and a compound according to one of Formulas II-A, II-B, II-C, II-D, II-E, II-F, II-G, or II-H as the cation. For example, the organic salt can include a halide anion and a 2-substituted imidazolium cation.

In other embodiments, the organic salt includes a substituted or unsubstituted sulfonate (e.g., —SO₃CF₃ or —SO₃R, where R is an alkyl, alkanol, halogen, or amine) as the anion and a compound according to one of Formulas II-A, II-B, II-C, II-D, II-E, II-F, II-G, or II-H as the cation. For example, the organic salt can include a trifluoromethanesulfonate anion and a substituted imidazolium cation.

In one aspect, the organic salt is an imidazolium-based or pyrrolidinium-based organic salt. Exemplary methods for producing imidazolium-based organic salts are disclosed in PCT Application No. PCT/US08/86434, which is incorporated by reference herein in its entirety for its teachings of imidazolium-based organic salts, their methods of making, and use. Organic salts can be synthesized as custom or “task-specific” compounds with functional groups that enhance physical properties, provide improved interaction with solutes, or are themselves chemically reactive. Many imidazolium-based organic salts are miscible with one another or with other solvents; thus, mixtures of organic salts serve to multiply the possibilities for creating a desired solvent for any particular application. In some embodiments, the organic salt comprises an imidazole core structure moiety. In one embodiment, the organic salt is an imidazolium-based organic salt.

In one embodiment, the organic salt is selected from the group consisting of 1-butyl-3-methylimidazolium bis[(trifluoromethyl)sulfonyl]imide ([C₄mim][Tf₂N]), 1-butyl-2,3-dimethylimidazolium chloride (C₄mmim][Cl]), 1-butyl-2,3-dimethylimidazolium bromide (C₄mmim][Br]), 1-butyl-3-methylimidazolium chloride (C₄mim][Cl]), 1-butyl-3-methylimidazolium bromide (C₄mim][Br]), 1-hexyl-3-methylimidazolium bis[(trifluoromethyl)sulfonyl]imide ([C₆mim][Tf₂N]), 1-ethyl-3-methylimidazolium trifluoromethanesulfonate ([C₂mim][OTf]), 1-decyl-3-methylimidazolium trifluoromethanesulfonate ([C₁₀mim][OTf]), 1-ethyl-2,3-dimethylimidazolium chloride (C₂mmim][Cl]), 1-ethyl-2,3-dimethylimidazolium bromide (C₂mmim][Br]), 1-ethyl-3-methylimidazolium chloride (C₂mim][Cl]), 1-ethyl-3-methylimidazolium bromide (C₂mmim][Br]), 1-ethyl-3-methylimidazolium bis[(trifluoromethyl)sulfonyl]imide ([C₂mim][Tf₂N]), 1-butyl-3-methyl-imidazolium trifluoromethanesulfonate ([C₄mim][OTf]), 1-ethyl-1-methylpyrrolidinium bromide ([C₂C₁Pyrr][Br]), 1-butyl-1-methylpyrrolidinium bromide ([C₄C₁Pyrr][Br]), 1-ethyl-1-methylpyrrolidinium bis[(trifluoromethyl)sulfonyl]imide ([C₂C₁Pyrr][Tf₂N]), 1-butyl-1-methylpyrrolidinium bis[(trifluoromethyl)sulfonyl]imide ([C₄C₁Pyrr][Tf₂N]), 1-ethyl-1-methylpyrrolidinium trifluoromethanesulfonate ([C₂C₁Pyrr][OTf]),1-butyl-1-methylpyrrolidinium trifluoromethanesulfonate ([C₄C₁Pyrr][OTf]) and combinations thereof.

The percentage of the organic salt in the composition is such that, when the composition absorbs an acid gas from a gas mixture, the absorbed acid gas is released from the composition by heating, when the heating does not cause appreciable loss of the water in the composition. In one embodiment, the loss of the water is less than about 10% (e.g., less than about 9%, less than about 8%, less than about 7%, less than about 6%, less than about 5%, less than about 4%, less than about 3%, less than about 2%, or less than about 1%, based on the water in the composition). The percentage of organic salt can be from about 10 to about 90% or from 30% to about 70% based on the weight of the composition. For example, the percentage of organic salt can comprise about 10%, about 15%, about 20%, about 25%, about 30%, about 35%, about 40%, about 45%, about 50%, about 55%, about 60%, or about 65% of the system, where any of the stated values can form an upper or lower endpoint of a range.

In some embodiments, the organic salt and amine are present in the composition in a ratio of organic solvent to amine of from 4:1 to 1:4. For example, the organic salt to amine ratio can be 4:1, 3:1, 2:1, 1:1, 1:2, 1:3, or 1:4, where any of the stated values can form an upper or lower endpoint of a range.

### Water

The composition can further include water. The percentage of the water in the composition is such that, when the composition absorbs an acid gas from a gas stream, the adduct formed between the amine and the acid gas does not precipitate out of the composition. This amount of water thus inhibits the loss of the amine. In one embodiment, the composition does not absorb significant amounts of water from the gas mixture. In another embodiment, the percentage of the water in the composition changes less than 5% after contacting the composition with the gas mixture. In another embodiment, the percentage of the water ranges from about 0% to about 15%. For example, the percentage of water can be about 1%, about 2%, about 3%, about 4%, about 5%, about 6%, about 7%, about 8%, about 9%, about 10%, about 11%, about 12%, about 13%, about 14%, or about 15%, where any of the stated values can form an upper or lower endpoint of a range.

Optionally, the composition further comprises a physical solvent. This solvent can be one or more of different organic salts, an organic physical solvent, water, or a mixture thereof. Exemplary organic physical solvents that can be used with compositions and methods disclosed herein include, but are not limited to, methanol, ethanol, propanol, glycols, acetonitrile, dimethyl sulfoxide, sulfolane, dimethylformamide, acetone, dichloromethane, chloroform, tetrahydrofuran, ethyl acetate, 2-butanone, toluene, imidazoles, as well as other organic solvents known to one skilled in the art.

The compounds according to Formula I and Formula II can be prepared in a variety of ways known to one skilled in the art of organic synthesis or variations thereon as appreciated by those skilled in the art. The compounds described herein can be prepared from readily available starting materials. Optimum reaction conditions can vary with the particular reactants or solvents used, but such conditions can be determined by one skilled in the art. The use of protection and deprotection, and the selection of appropriate protecting groups can be determined by one skilled in the art. The chemistry of protecting groups can be found, for example, in Wuts and Greene, Protective Groups in Organic Synthesis, 4th Ed., Wiley & Sons, 2006, which is incorporated herein by reference in its entirety.

Variations on Formula I and Formula II include the addition, subtraction, or movement of the various substituents as described for each compound. Similarly, when one or more chiral centers are present in a molecule, the chirality of the molecule can be changed. Additionally, compound synthesis can involve the protection and deprotection of various chemical groups.

The organic salts and amines or the starting materials and reagents used in preparing the disclosed compounds are either available from commercial suppliers such as Aldrich Chemical Co., (Milwaukee, Wis.), Acros Organics (Morris Plains, N.J.), Fisher Scientific (Pittsburgh, Pa.), Sigma (St. Louis, Mo.), Pfizer (New York, N.Y.), GlaxoSmithKline (Raleigh, N.C.), Merck (Whitehouse Station, N.J.), Johnson & Johnson (New Brunswick, N.J.), Aventis (Bridgewater, N.J.), AstraZeneca (Wilmington, Del.), Novartis (Basel, Switzerland), Wyeth (Madison, N.J.), Bristol-Myers-Squibb (New York, N.Y.), Roche (Basel, Switzerland), Lilly (Indianapolis, Ind.), Abbott (Abbott Park, Ill.), Schering Plough (Kenilworth, N.J.), or Boehringer Ingelheim (Ingelheim, Germany), or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Reactions to produce the compounds described herein can be carried out in solvents, which can be selected by one of skill in the art of organic synthesis. Solvents can be substantially nonreactive with the starting materials (reactants), the intermediates, or products under the conditions at which the reactions are carried out, i.e., temperature and pressure. Reactions can be carried out in one solvent or a mixture of more than one solvent. Product or intermediate formation can be monitored according to any suitable method known in the art. For example, product formation can be monitored by spectroscopic means, such as nuclear magnetic resonance spectroscopy (e.g., ¹H or ¹³C) infrared spectroscopy, spectrophotometry (e.g., UV-visible), or mass spectrometry, or by chromatography such as high performance liquid chromatography (HPLC) or thin layer chromatography.

### Methods

Disclosed are methods of purifying a gas mixture, wherein the gas mixture comprises an acid gas. The method comprises the step of providing a composition comprising an organic salt, an amine and water. The method further provides the step of contacting the composition with the gas mixture, whereby the acid gas is absorbed and covalently bound in the composition. The method further comprises the step of releasing the acid gas from the composition by heating the composition, wherein the heating does not cause significant loss of the water in the composition. In the disclosed methods, the adduct formed between the amine and the acid gas does not precipitate out of the composition.

In one embodiment, the acid gas comprises a compound selected from the group consisting of CO₂, COS, CS₂, SO₂, SO₃, H₂S, N₂O, NO, N₂O₃, NO₂, N₂O₄, and N₂O₅. In another embodiment, the said acid gas comprises CO₂, SO₂, SO₃, and H₂S. In yet another embodiment, the said acid gas comprises CO₂.

In one embodiment, the loss of the water is less than about 10%. In another embodiment, the loss of the water is less than about 5%.

In one embodiment, the composition does not absorb significant amounts of water from the gas mixture. In another embodiment, the percentage of the water in the composition changes less than 5% after contacting the composition with the gas mixture.

The process of absorbing CO₂ from a gas stream using a mixture of organic salts and amine (the “amine-organic salt solvent”) can be optimized for performance by managing the water content of the amine-organic salt solvent. Among the parameters that can be optimized include viscosity of the amine-organic salt solvent, rate of amine degradation, composition of amine degradation products, CO₂ absorption, solvent vapor pressure and overall energy consumption of the system.

Effective water content in the amine-organic salt solvent can be determined by analyzing the viscosity profile of the amine-organic salt solvent against the following variables: temperature, CO₂ partial pressure, water content of the amine-organic salt solvent, and CO₂ loading. In some embodiments, the effective water content can be determined by analyzing the vapor liquid equilibrium for the amine-organic salt solvent for CO₂ or water. In other embodiments, the effective water content can be determined by considering the cost of the amine-organic salt solvent which is a function of organic salt composition, amine composition, and/or amine-organic salt water loading. In further embodiments, the effective water content can be determined by considering the life-expectancy (alternatively the amount of “make-up” needed) of the amine-organic salt solvent as a function of: amine-organic salt composition, water composition, temperature, or gas composition. The effective water content can also be decided by determining the energy of regeneration as a function of water content.

In one embodiment, the amine is selected from the group consisting of a monoamine, diamine, polyamine, polyethylene amine, amino acid, neutral N-heterocycle, neutral N-heterocyclic-alkyl-amine, and combinations thereof. In another embodiment, the amine is selected from the group consisting of monoethanolamine, N-methyl-monoethanolamine, diglycolamine, diethanolamine, diisopropanolamine, triethanolamine, methyldiethanolamine, N-methyldiethanolamine, monethanolamine, 2-amino-2-methyl-1 -propanol, diglycolamine, diethanolamine, diethylenetriamine, spermidine, triethylenetetramine, spermine, and combinations and derivatives thereof.

In one embodiment, the organic salt is selected from the group consisting of 1-butyl-3-methylimidazolium bis[(trifluoromethyl)sulfonyl]imide ([C₄mim][Tf₂N]), 1-butyl-2,3-dimethylimidazolium chloride (C₄mmim][Cl]), 1-butyl-2,3-dimethylimidazolium bromide (C₄mmim][Br]), 1-butyl-3-methylimidazolium chloride (C₄mim][Cl]), 1-butyl-3-methylimidazolium bromide (C₄mim][Br]), 1-hexyl-3-methylimidazolium bis[(trifluoromethyl)sulfonyl]imide ([C₆mim][Tf₂N]), 1-ethyl-3-methylimidazolium trifluoromethanesulfonate ([C₂mim][OTf]), 1-decyl-3-methylimidazolium trifluoromethanesulfonate ([C₁₀mim][OTf]), 1-ethyl-2,3-dimethylimidazolium chloride (C₂mmim][Cl]), 1-ethyl-2,3-dimethylimidazolium bromide (C₂mmim][Br]), 1-ethyl-3-methylimidazolium chloride (C₂mim][Cl]), 1-ethyl-3-methylimidazolium bromide (C₂mmim][Br]), 1-ethyl-3-methylimidazolium bis[(trifluoromethyl)sulfonyl]imide ([C₂mim][Tf₂N]), 1-butyl-3-methyl-imidazolium trifluoromethanesulfonate ([C₄mim][OTf]), 1-ethyl-1-methylpyrrolidinium bromide ([C₂C₁Pyrr][Br]), 1-butyl-1-methylpyrrolidinium bromide ([C4CiPyrr][Br]), 1-ethyl-1-methylpyrrolidinium bis[(trifluoromethyl)sulfonyl]imide ([C₂C₁Pyrr][Tf₂N]), 1-butyl-1-methylpyrrolidinium bis [(trifluoromethyl)sulfonyl]imide ([C4CiPyrr][Tf₂N]), 1-ethyl-1-methylpyrrolidinium trifluoromethanesulfonate ([C₂C₁Pyrr][OTf]),1-butyl-1-methylpyrrolidinium trifluoromethanesulfonate ([C₄C₁Pyrr][OTf]) and combinations thereof.

In one embodiment, the percentage of the water inhibits degradation of the amine in the composition. In another embodiment, the percentage of the water ranges from about 5% to about 15%, more specifically from about 5% to about 10%, more specification from about 10% to about 15%, more specifically about 10%.

Also provided herein is a kit comprising at least one compound useful within the methods described herein and an instructional material that describes, for instance, using that at least one compound within the disclosed methods. Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

The examples below are intended to further illustrate certain aspects of the methods and compositions described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

Reagents for this study were purchased from commercial suppliers and used without further purification. Solvents were analyzed by GC/MS prior to this study to determine baseline impurities so they would not be mistaken for degradation products. Distilled water was used for all experiments. Reagents were procured from the following suppliers: monoethanolamine (MEA, 99% pure) and N-methylethanolamine (NMEA, 99% pure), from Univar USA; 1-ethyl-3-methylimidazolin ethylsulfate ([Emim][EtSO₄]) from Evonik Industries; 1-ethyl-3-methylimidazolium trifluoromethanesulfonate ([Emim][OTf], 98% pure) from Io-Li-Tec USA. Industrial grade N₂ (99.00% pure), CO₂ (98.00% pure) and 1000 ppm SO₂ in N₂ (confirmed by gas analysis performed by vendor) cylinders were all obtained from General Air. Air was obtained from the atmosphere using an aquarium pump.

### Example 1

### Effect of Water on Carbamate Salt Formation

An anhydrous solvent containing 33% N-methyl-ethanolamine (NMEA) in [Emim][C₂H₅SO₄] (IMES^{TM} supplied by Evonik) was tested in a CO₂ absorption study. Carbamate salts precipitated out, thus clogging the columns and tubing within the testing instrument (see FIG. 2).

A second study was conducted by adding about 5% water to the solution of 33% NMEA in IMES to form a system. The resulting system was tested in CO₂ absorption studies. The system did not show any solid carbamate crystal formation, as opposed to results seen in the anhydrous solvent runs. Additionally, no water was observed to have been vaporized from the solution in the flash drums and recondensed in the accumulator vessel.

### Example 2

### Effect of Water on Viscosity

The viscosities of systems containing organic salts and amines, with and without water, were tested. A Brookfield DVII+Pro viscometer was used for viscosity measurements. Table 1 summarizes the results on the experiment, highlighting the effect of water on viscosity.

TABLE 1

| | Volume (%) | | | | | | | | | | |
|---|---|---|---|---|---|---|---|---|---|---|---|
| Ref. | Organic | | | | mol fraction | | | | | Temp | Viscosity |
| No. | Salt | MEA | MDEA | H₂O | Salt | MEA | MDEA | H₂O | CO₂* | (° C.) | (cP) |
| 1 | 41.3 | 58.7 | 0 | 0 | 0.18 | 0.82 | 0.00 | 0.00 | 73.1 | 40 | 620 |
| 2 | 39.6 | 29.6 | 30.7 | 0 | 0.21 | 0.51 | 0.27 | 0.00 | 65.3 | 40 | 463 |
| 3 | 35.8 | 54.5 | 0 | 9.74 | 0.11 | 0.56 | 0.00 | 0.33 | 70.6 | 40 | 137 |
| 4 | 32.4 | 47.7 | 0 | 19.9 | 0.08 | 0.39 | 0.00 | 0.53 | 72.7 | 40 | 63 |
| 5 | 29.8 | 29.8 | 30.0 | 10.3 | 0.10 | 0.34 | 0.17 | 0.38 | 72.0 | 40 | 169 |
| 6 | 20.8 | 59.2 | 0 | 20 | 0.05 | 0.45 | 0.00 | 0.50 | 70.6 | 40 | 113 |
| 7 | 40.3 | 38.9 | 0 | 20.7 | 0.10 | 0.33 | 0.00 | 0.57 | 73.3 | 40 | 75 |
| 8 | 30.3 | 39.7 | 0 | 30 | 0.06 | 0.27 | 0.00 | 0.67 | 68.4 | 40 | 29 |
| 9 | 19.8 | 38.7 | 0 | 41.5 | 0.03 | 0.21 | 0.00 | 0.75 | 74.0 | 40 | 17 |
| 10 | 28.6 | 40.1 | 0 | 31.3 | 0.06 | 0.27 | 0.00 | 0.68 | 82.9 | 30 | 35 |
| 11 | 29.2 | 40.5 | 0 | 30.2 | 0.06 | 0.27 | 0.00 | 0.67 | 54.0 | 50 | 27 |

*Percentage of theoretical CO₂ loading

### Example 3

### Preliminary Degradation and Stability Study

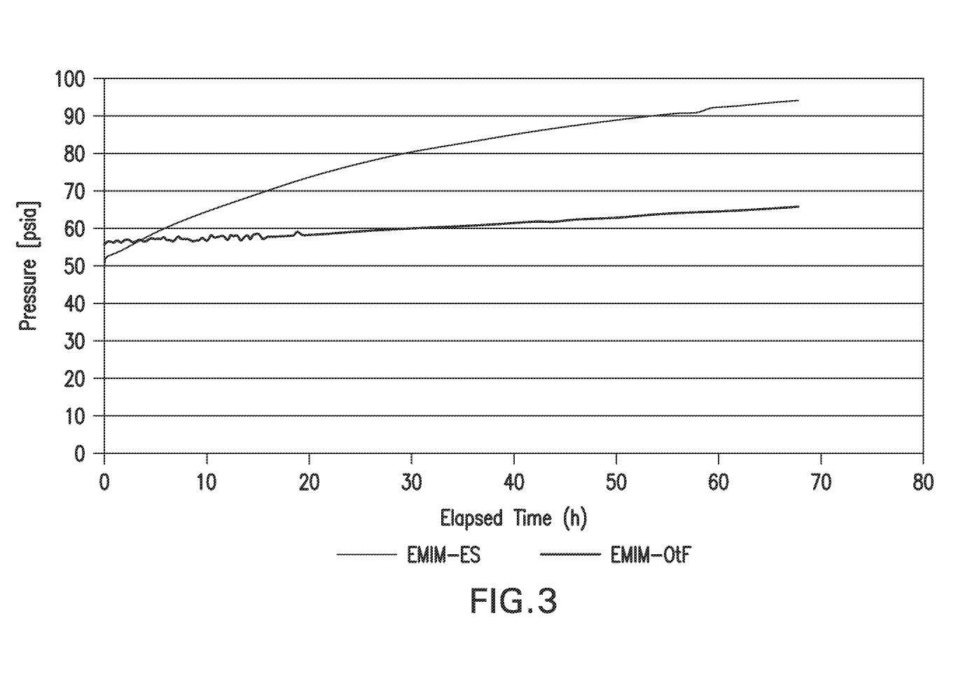

Solvents for the degradation and stability study were prepared containing the following components: Solvent A: 33% NMEA, 57% [Emim][EtSO₄], 10% water; Solvent B: 33% NMEA, 57% [Emim][OTf], 10% water. The pressure of the two organic salts was determined using a vapor liquid equilibrium (VLE) apparatus. FIG. 3 depicts the vapor liquid equilibrium data as a function of pressure over time.

Solvent B contains the inert triflate anion. As shown in FIG. 3, the pressure in the VLE cell containing Solvent B remained relatively constant over time. Solvent A, however, contains a reactive ethylsulfate anion. The pressure in the VLE cell containing Solvent A increased over time. Not to be bound by theory, this is likely a result of the amine being alkylated by the ethylsulfate anion, which decreases carrying capacity. This results in more CO₂ gas in the vessel, and hence, a pressure increase over time.

### Example 4

### Solvent Aging and Degradation Monitoring for Systems Containing [Emim][EtSO₄] or [Emim][OH]

### Solvent Aging Procedure

Solvents for aging experiments were mixed in the following proportions by weight to prepare 60 g total for each. Aqueous MEA: 30% MEA, 70% water; Solvent A: 33% NMEA, 57% [Emim][EtSO₄], 10% water; Solvent B: 33% NMEA, 57% [Emim][OTf], 10% water. The solvent was then sparged with N₂ and stirred for 15 minutes to remove any dissolved gases. Solvent (20 mL) was added to a 50-mL cylinder (Swagelok SS-4CS-TW-50) fitted with a ball valve (Swagelok SS-43G86) and a high-temperature silicone septum. All Swagelok vessels and fittings are made of 316 stainless steel. The gas of interest (N₂, air, CO₂ or SO₂) was bubbled through the solvent for 5 minutes via 12 in. needle while venting through the septum with a disposable, single-use needle. The cylinder was then sealed and placed in a laboratory oven set to 120° C. (Boekel Scientific; Feasterville, PA) and allowed to age for a period of time.

### Sampling and Dilution /Extraction Procedure

Samples of aged solvent were acquired at pre-determined intervals to monitor degradation. The cylinders were removed from the oven and allowed to cool to room temperature for approximately one hour. The valve was opened carefully in a ventilated fume hood (even at room temperature cylinders containing CO₂ were still under high pressure), and a plastic syringe (Norm-Ject from Henke Sass Wolf; Tuttlingen, Germany) with a 12 in. stainless steel needle was used to extract 1 mL of solvent through the septum. The same 12 in. needle was then used to sparge the solvent with the gas used to age the sample. The needle was then removed quickly, the valve was sealed, and the cylinder was placed back in the oven until another sample was acquired.

Samples of aqueous MEA were diluted tenfold with high purity anhydrous MeOH (Honeywell B&J, Morristown, N.J.; 99.99% pure). Samples of Solvents A and B containing IL-based solvents were treated differently because the low volatility ionic components may foul GC columns. For these samples, the organics were extracted into a 1:1 mixture of EtOAc and hexanes (both HPLC-UV grade from Pharmco-AAPER) which phase separated from the aged solvent. These extractions were done in a 5-mL plastic syringe by pulling 1 mL of solvent from the aging cylinder, changing to a clean needle, then pulling 2 mL of the 1:1 EtOAc-hexanes mixture and approximately 1 mL of air. The syringe was shaken vigorously and the two phases were allowed to separate, with the denser IL-containing solvent on the bottom layer. The bottom layer was discarded along with 0.5 mL of the EtOAc-hexane to ensure the entire organic salt layer was washed away. All samples were filtered through Millex 0.45 μm PTFE syringe filters (Millipore; Billerica, Mass.) while transferring to GC autosampler vials to remove any particulates.

### GC/MS Analysis and Data Workup

GC/MS analysis was conducted using a Hewlett Packard 6890 Series GC with a 6890 Series autoinjector coupled to a Hewlett Packard 5973 mass selective detector. The carrier gas was high purity helium (99.999% pure) and a RESTEK Rtx-5 Amine column (30 m long, 0.32 mm diameter, 1 μm film thickness) was used in this study. Separations were performed with a temperature profile beginning at 80° C. and ramping 15° C/min to 220° C. with a helium flow rate of 1.5 mL/min. Data analysis was conducted using Chem Station (Version D.00.01.27) and AMDIS (Version 2.66) software packages to analyze chromatograms. The 50 largest area peaks (excluding carrier gas and extraction/dilution solvents) were identified using the NIST MS Search program (Version 2.00.

### NMR Experimental

NMR experiments were conducted on a Bruker 500 MHz instrument in DMSO-d6 (some spectra contain TMS as an internal standard). All initial mixtures contained a 60:40 (vol:vol) mixture of [Emim][EtSO₄] and NMEA . Samples for ¹H NMR were taken from the bulk solvent (˜50 mL) after exposing the mixture to heat (80-120° C.) and adding enough CO₂ (on a theoretical 1:2 basis) to saturate all amine molecules. The degradation accelerated aging experiments were carried out in stainless steel chambers similar to the method described above.

### Results:

Aqueous MEA: Aging experiments were conducted with 30% aqueous MEA at 120° C. in sealed cylinders under the studied gases, as described above. Degradation was negligible under N₂ after four weeks and was slightly more prevalent in the presence of air. Air-exposed samples contained ammonia and hydroxylamine after three days of aging, but no organic impurities were detected. As with all other solvents in this study, degradation of MEA was observed to increase with CO₂ relative to the other gases. Samples aged in the presence of CO₂ contained hydroxylamine and ammonia after one day in the oven at 120° C. No further degradation was observed with these samples until after three weeks, at which point oxazolidinone (1) and amine dimers (2 and 3) were detected (Scheme 1).

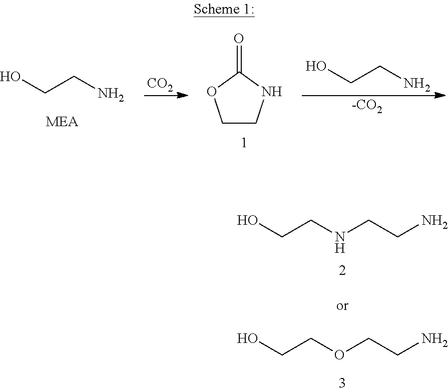

The carbamate oligomerization pathway outlined in Scheme 1 is common for these types of alkanolamine systems (see Lepaumier et al., Chem. Eng. Sci., 2011, 66, 3491-3498). When the amine is exposed to CO₂, it forms the semi-stable oxazolidinone 1 which is electrophilic and can react with the nucleophilic amine via a S_{N}2 reaction mechanism. Depending on which component of the amine acts as the nucleophile in this reaction, different degradation products (i.e., 2 or 3) are possible. The amine oligomers will continue to react with 1 to build larger oligomers and polymers. However, detection of these higher molecular weight compounds was limited in this study because GC/MS can only detect volatile compounds and such polymers have high boiling points. The carbamate oligomerization amine degradation pathway observed for aqueous MEA in this study has also been reported by other authors studying degradation of alkanolamines (see, for example, Strazisar et al., Energ. Fuels, 2003, 17, 1034-1039 and Lepaumier et al., Chem. Eng. Sci., 2011, 66, 3491-3498).

Solvent A: Solvent A is a mixture of water, NMEA, and [Emim][EtSO₄] and was aged under the same conditions as aqueous MEA. This solvent degrades faster than other solvents containing organic salts, so samples were taken more frequently, and the duration of the experiment was shorter than for MEA or Solvent B. The solvent underwent similar carbamate oligomerization of NMEA to that observed for MEA, however this was not the primary method of solvent degradation. The EtSO₄ anion is electrophilic and nucleophilic amine alkylation was the most significant form of solvent degradation.

Like MEA, NMEA is capable of forming a reactive oxazolidinone (4, Scheme 2) when exposed to CO₂. Compound 4 was detected after one day of aging in the presence of CO₂. After one week, amine dimers (5 and 6, Scheme 2) began forming due to NMEA reacting with 4. These degradation products were not detected for samples aged under N₂ or air, indicating CO₂ is required to form 4.

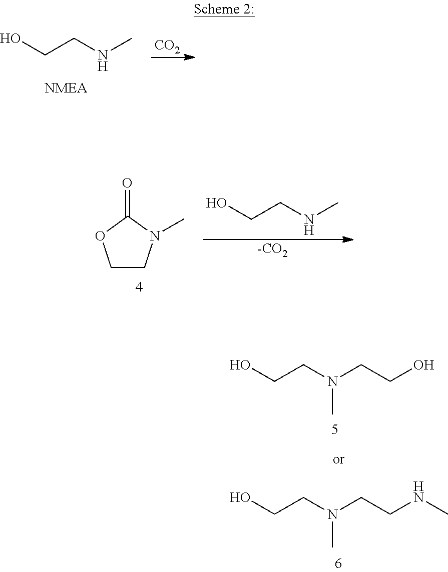

Formation of amine-carbamate oligomers was a secondary degradation mechanism of Solvent A, which only occurs in the presence of CO₂. The primary degradation pathway of Solvent A is alkylation of the amine by the [Emim] [EtSO₄] anion. After one week of aging, all samples contained alkylated NMEA compounds. The ethylsulfate anion is a strong electrophile and is known to act as an alkylating agent in aqueous environments (see Wolfenden, R.; Yuan, Y. Proc. Nat. Acad. Sci. 2007, 104, 83-86). This behavior is observed in this solvent environment with elevated temperatures. The presence of N-ethyl-N-methylethanolamine (7) in the aged samples was a strong indicator that this alkylation reaction between NMEA and the ethylsulfate anion was occurring as a primary degradation mechanism independent of the CO₂-promoted carbamate oligomerization observed for MEA (Scheme 3).

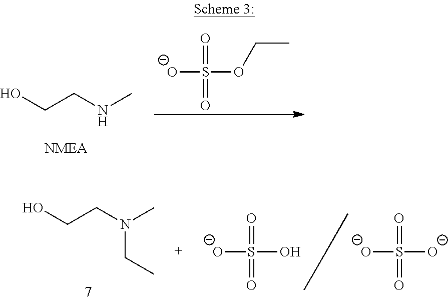

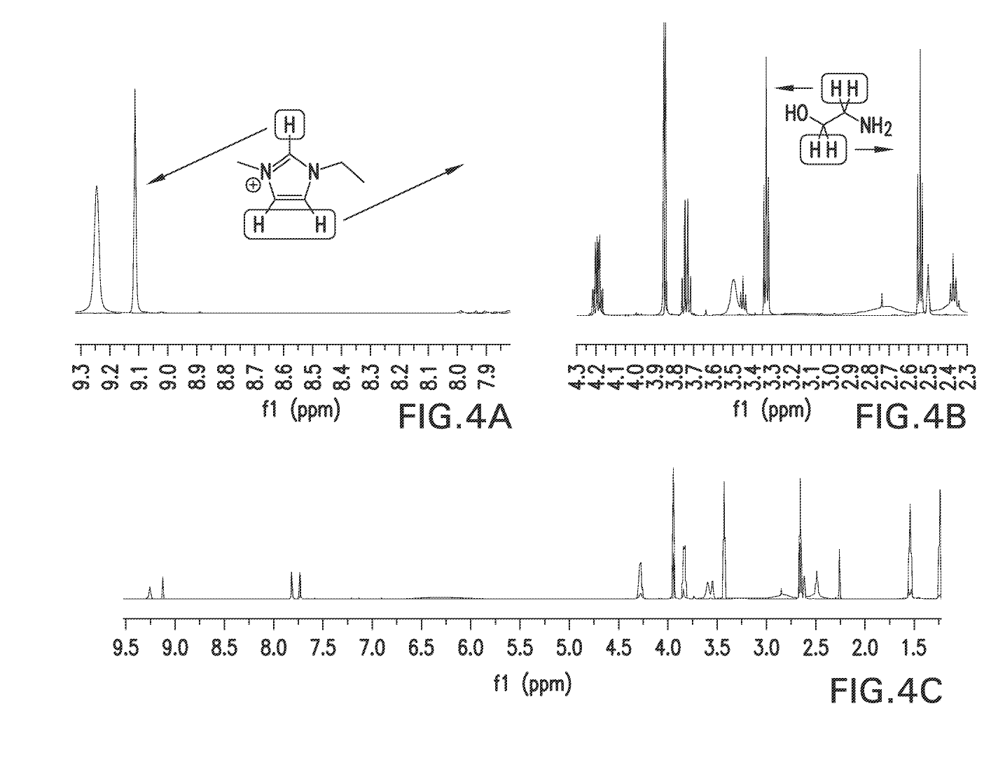

Additional characterization of amine alkylation by the organic salt [Emim][EtSO₄] was performed via ¹H NMR spectroscopy. Spectra of [Emim][EtSO₄] and MEA were acquired for virgin and aged samples and the overlaid spectra are shown in FIG. 4. FIG. 4c shows an overlay plot of the entire spectrum and clear differences are apparent in the sample after aging, indicating chemical changes to both the organic salt and amine. The chemical shifts of the methylene protons on MEA change after aging the solvent, as seen by the disappearance of the signals at 2.55 and 3.32 ppm in the red spectrum (FIG. 4b). This is attributed to alkylation of the amine by the ethylsulfate anion, in addition to formation of amine carbamates. The chemical shifts of the protons on the imidazolium cation of the IL also change from the virgin to the aged sample. FIG. 4a shows the aromatic region of the NMR spectrum where the proton at the C(2)-position of the cation has shifted from 9.13 to 9.26 after aging. Smaller changes are also observed for the protons at the 4- and 5-positions. This is likely due to chemical changes to the anion from ethylsulfate to sulfate and/or hydrogen sulfate after alkylation of the amine. Changes to the composition of the anion are known to affect the chemical shift of the imidazolium protons in the ¹H NMR spectrum (see LaFrate, A. L.; Gin, D. L.; Noble, R. D. Ind. Eng. Chem. Res. 2010, 49, 11914-11919). These NMR spectra further support alkylation of the amine by the ethylsulfate anion as the primary degradation mechanism of Solvent A.

Solvent B: Degradation was prominent in Solvent B which contains the IL [Emim][OTf]. The primary mechanism was amine-carbamate oligomerization, which led to a greater variety of degradation products than those observed in aqueous MEA or Solvent A. Not only were more degradation products detected in this solvent, but they also formed earlier than in the other solvents, with many appearing within one week in the oven and several after 24 hours. As with the other solvents, degradation was more rapid and produced a wider array of compounds under CO₂ compared to air or N₂. The initial degradation steps for Solvent B were identical to those shown in Scheme 2 for Solvent A: NMEA reacts with CO₂ to form oxazolidinone 4, which then reacts with NMEA to form dimers 5 and 6. However, unlike with Solvent A, dimers 5 and 6 continued to react in Solvent B forming multiple piperazine derivatives (Scheme 4). For example, dimer 6 can react again with CO₂ to form a reactive electrophilic carbamate species which can then undergo intramolecular nucleophilic attack to form dimethylpiperazine (8). Similarly, 6 can react with CO₂ to form the reactive carbamate intermediate and undergo an intermolecular nucleophilic attack from another NMEA molecule to form a trimer, which can then cyclize to form 9. Compound 10 was detected in some degradation samples and results from the loss of a methyl group on the piperazine. Not to be bound by theory, this likely occurs by a radical mechanism, which could be promoted by metal ions, such as Fe³⁺, present in solution as a result of corrosion.

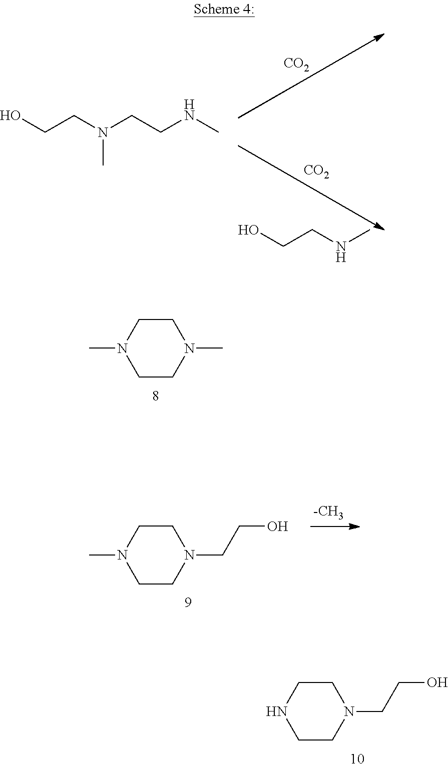

The increased rate of degradation and greater abundance of carbamate oligomerization products in Solvent B can likely be attributed to the organic salt component of the solvent. The primary mechanism of degradation in Solvent A was amine alkylation by the ethylsulfate anion, which obscured the secondary degradation mechanism of amine carbamate polymerization. Because this process formed a tertiary amine (7) which cannot oligomerize in the same manner as NMEA or MEA (secondary and primary amines respectively), these products were less abundant in Solvent A. The triflate anion of the organic salt in Solvent B is not electrophilic and cannot undergo an amine alkylation degradation mechanism as observed in Solvent A (i.e., no “shift” of the —CF₃ group is possible). Thus NMEA is available in solution and readily undergoes carbamate oligomerization and cyclization reactions to produce piperazine derivatives. Such organic salts increase the rate of substitution reactions such as these, which can be a factor in why more of these products are seen in Solvent B than with aqueous MEA (see Kim et al., 2003, 68, 4281-4285).

Another aspect to consider for Solvent B is purity of the organic salt used in the study and its degradation. Traces of imidazoles (1-methyl- and 1-ethylimidazole) were present in the

[Emim][OTf] used in this study and also in all of the degradation samples analyzed. These compounds are themselves reactive, so it is possible they play a role in degradation reaction pathways or react to form degradation products. Because this study was not quantitative it is not possible to say whether the concentration of imidazoles increased during the study. Degradation of the organic salt itself could produce these types of compounds and they are also known to form as degradation products of NMEA in aqueous systems. Lepaumier et al. report the presence of multiple imidazole degradation products in aqueous NMEA, which they attribute to reaction of the amine with formic acid (see Lepaumier et al., Chem. Eng. Sci., 2011, 66, 3491-3498).

SO₂. Degradation: Samples of all three solvents were aged under SO₂, and GC/MS was used to monitor formation of degradation products. In the case of all three solvents, degradation was slower and fewer degradation products were observed in the presence of SO₂ than with CO₂. SO₂ is much more toxic to humans than CO₂, is a strong oxidizer, and is generally thought of as a problematic impurity in flue gas and in the atmosphere. Given the highly reactive/acidic nature of SO₂, which can lead to more degradation, the SO₂ experiment was conducted for a shorter amount of time and samples were taken more frequently than for Solvent B or aqueous MEA. In the case of Solvent A, amine alkylation was still the primary degradation mechanism with significant amounts of alkylated amines appearing in less than a week. For aqueous MEA and Solvent B, amine oligomerization was the primary degradation pathway and identical products to those seen with CO₂ were observed in the presence of SO₂. In the case of all solvents studied here, none of the degradation products observed by GC/MS contained any sulfur atoms.

### Example 5

### Solubility and Miscibility

A number of organic salts proposed for use as CO₂ capture solvents are unsuitable due to solubility and/or miscibility problems with the water and/or amine components of the solvents. Table 2 provides solubility results for certain organic salts with N-methylethanolamine and water mixtures.

TABLE 2

Organic Salt

| Cation | Anion | Result |
|---|---|---|
| 1-Hexyl-2-methylimidazolium | Chloride | Partially insoluble |
| 1-Ethyl-3-methylimidazolium | Chloride | Soluble |
| 1-Ethyl-3-methylimidazolium | Tf₂N | Insoluble |
| 1-Ethyl-3-methylimidazolium | Triflate | Soluble |

Organic salts were also tested for solubility with various amines, including monoethanolamine (MEA), diethanolamine (DEA), or diethylenetetramine (DETA). Table 3 provides the solubility results for the organic salt-amine systems and the organic salt-amine-carbamate systems.

TABLE 3

| | | | Carbamate |
|---|---|---|---|
| Organic Salt | Amine | Soluble | Soluble |
| 1-hydroxyethyl-3-methylimidazolium | DEA | Yes | Yes |
| Tf₂N^{a} | | | |
| 1-hydroxyethyl-3-methylimidazolium | MEA | Yes | No |
| Tf₂N^{a} | | | |
| 1-hexyl-3-methylimidazolium Tf₂N^{a,b} | DEA | No | No |
| 1-hexyl-3-methylimidazolium Tf₂N^{a} | MEA | Yes | No |
| 1-butyl-3-methylimidazolium Tf₂N^{a} | DEA | No | No |
| 1-ethyl-3-methylimidazolium Tf₂N^{b} | DEA | No | No |
| 1-butyl-3-methylimidazolium BF₄^{c} | MEA | Yes | No |
| 1-butyl-3-methylimidazolium OTf^{c} | MEA | Yes | No |
| Tetradecyl(trihexyl)phosphonium Cl^{a} | DETA | Yes | No |

^{a}Camper et. al., Ind. Eng. Chem. Res., 2008, 47, 8496-8498
^{b}Hasib-ur-Rahman et. al., Int. J. Greenh. Gas Control, 2012, 6, 246-252
^{c}Huang et. al., Energy Environ. Sci., 2011, 4, 2125-2133
^{d}Harper et. al, Ind. Eng. Chem. Res., 2011, 50, 2822-2830

### Example 6

### Solvent Aging and Degradation Monitoring for Systems Containing Halide

### Organic Salts

A thermal degradation study of five halide organic salts was performed under simulated regeneration conditions in the absence of CO₂ or amine-bound carbamates. The purpose of the study was to determine which, if any, halide organic salts are stable under basic, aqueous conditions at 120° C. for 1 week. The amine used in this study was monoethanolamine (MEA). The solvent mixtures were composed of approximately 57% organic salt, 33% MEA, and 10% distilled water (wt. %).

The organic salts used in this study include 1-butyl-3-methylimidazolium chloride [Bmim][Cl], 1-butyl-2,3-methylimidazolium chloride [Bmmim ][Cl], 1-ethyl-3-methylimidazolium chloride [Emim][Cl], 1-ethyl-3-methylimidazolium bromide [Emim][Br], and 1-ethyl-2,3-dimethylimidazolium bromide [Emmim][Br]. These organic salts were chosen to investigate the effects of a protected C2-position (methyl group vs. a hydrogen), a longer alkyl substituent (butyl vs. ethyl), and the type of anion (Br vs. Cl) on organic salt stability. All mixtures were aged under air without sparging the sample. Stainless steel (316L) cylinders were used to age solvent mixtures at 120° C., and glass vials were used to age samples at room temperature (approximately 23° C.). Samples that were aged at the two conditions were taken from the same parent batch of solvent. The samples aged at room temperature served as a temperature control group for the 120° C. samples. GC/MS analyses of the samples were conducted by extracting the solvent mixture with ethyl acetate to isolate organic components from the organic salt, which may cause fouling of the GC column due to its low vapor pressure. Chromatograms were analyzed and the identity of peaks was determined using the NIST mass spectrometry library.

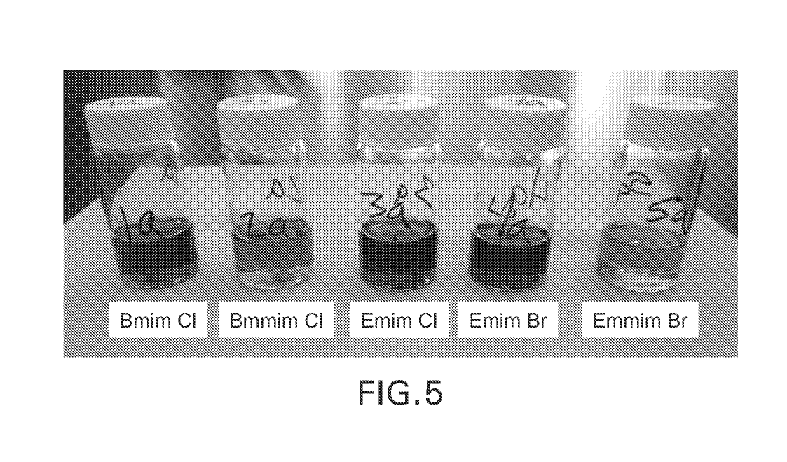

Samples were analyzed pre- and post-thermal aging with ¹H NMR spectroscopy (300 MHz) as well as with GC/MS. The samples aged at 120° C. for one week were noticeably more colored than the samples aged at room temperature, which were colorless. FIG. 5 shows the difference in color observed for the studied samples. A dark-amber color was observed for the samples composed of [Bmim][Cl], [Emim][Cl], and [Emim][Br]. However, the samples composed of [Bmmim][Cl] and [Emmim][Br] (both containing methyl groups at the 2-position) were observed to have a yellow color after aging at 120° C. This “yellowing” effect is typically observed when neat organic salt samples are heated for an extended period of time. Samples remained clear and free of precipitate in all cases studied here. The room temperature samples showed no change in color from the start to the end of experimentation.

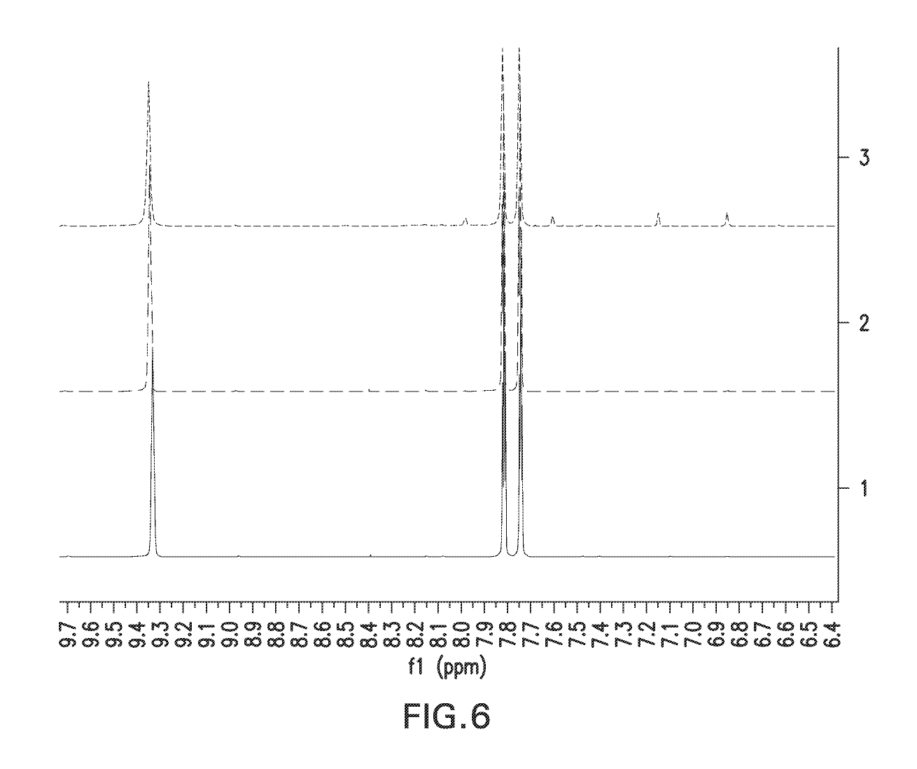

Evaluation of ¹H NMR spectra revealed that samples composed of [Bmmim][Cl] and [Emmim][Br] were more stable than the samples composed of [Bmim][Cl], [Emim][Cl], and [Emim] [Br] at 120° C. However, the amount of degradation that occurred in the latter three samples was no more than 10% (i.e., 90% or more of the original organic salt remained). A stacked plot of virgin, room-temperature aged, and 120° C. aged ¹H NMR spectra for the sample containing [Bmim][Cl] is shown in FIG. 6. This figure shows the imidazole/imidazolium region where degradation products are clearly observed in the 120° C. spectrum. Imidazole-based products appear to be the primary degradation structures observed in the NMR spectra of [Bmim][Cl] (FIG. 6) as well as with the spectra of samples composed of [Emim][Cl] and [Emim][Br]. No organic salt degradation was observed by NMR in any of the room-temperature samples.

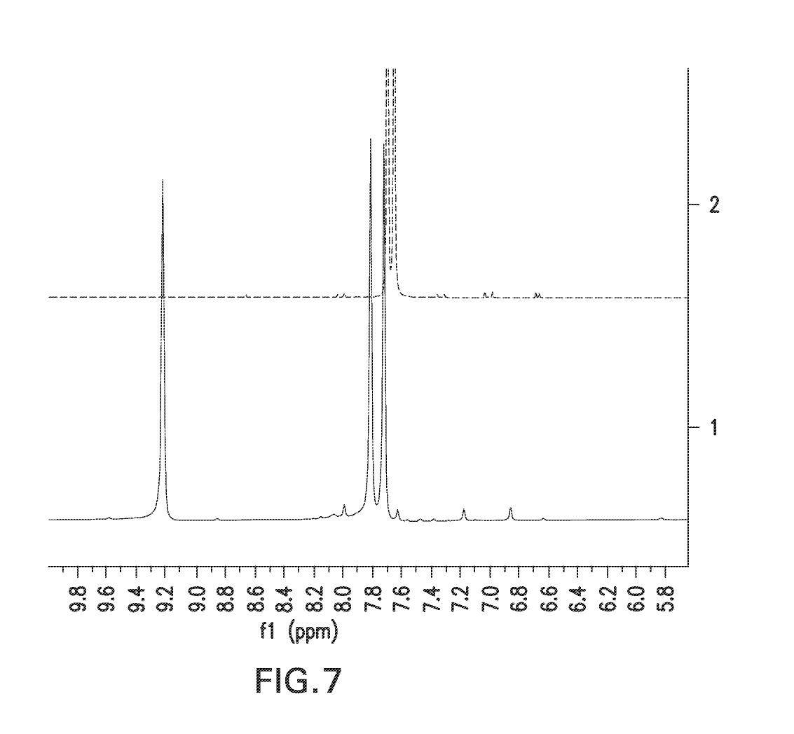

Effect of a protected C2-position: The effect of a protected C2-position on halide organic salt degradation was studied under two cases: (1) with a butyl substituent and a chloride anion (i.e., [Bmim][Cl] vs. [Bmmim][Cl]), and (2) with an ethyl substituent and a bromide anion (i.e., [Emim][Br] vs. [Emmim][Br]). In both cases the unprotected organic salts showed signs of degradation in the ¹H NMR spectra, where the methyl-protected organic salts showed little, if any, degradation products. The stability of the protected halide organic salts is demonstrated in the stacked ¹H NMR spectra of [Emim][Br]and [Emmim][Br] (aged at 120° C.) in FIG. 7. Degradation of [Emim] [Br] is evident in the imidazole/imidazolium region similar to [Bmim][Cl] (FIG. 6). This study indicates that protecting the C2-position reduces, or completely inhibits, halide organic salt degradation. As noted above, the amount of degradation in the unprotected organic salts was fairly minimal under the studied conditions.

GC/MS analysis also showed enhanced stability in samples containing organic salts with a protected C2-position. These organic salts showed fewer degradation products after aging at 120° C. for one week than those that were not protected. Samples containing organic salts with a proton at the C2-position showed significant quantities of alkylimidazole degradation products which were not present when in other “protected” samples. Additionally, shifting of alkyl groups on the imidazolium cation to amines was observed when there was just a proton at the C2-position. Not to be bound by theory, formation of both of these types of degradation products can likely be attributed to formation of reactive carbene species at the C2-position when it is not protected in a basic environment.

Effect of n-alkyl substituent length: The effect of an ethyl vs. butyl substituent on halide organic salt degradation was studied by comparing the ¹H NMR spectra of [Emim][Cl] vs. [Bmim][Cl]. Although both samples showed signs of degradation, [Emim][Cl] was nearly twice as stable as the [Bmim][Cl] (i.e. , nearly twice as much degradation occurred with [Bmim][Cl ] compared to [Emim][Cl]). Under the conditions studied here, a butyl-substituted halide organic salt is significantly less stable than an ethyl-substituted organic salt. The protected organic salts ([Emmim][Br] and [Bmmim][Cl]) were both observed to be stable regardless of alkyl substituent, as noted above. The GC/MS analysis of the samples confirmed what was observed in the NMR spectra. Although the GC/MS analysis was not quantitative, a larger amount of alkylimidazole degradation products seemed to be present in [Bmim][Cl] compared to the other samples analyzed.

Effect of anion: Aged samples composed of [Emim][Br] vs. [Emim][Cl] were evaluated with ¹H NMR spectroscopy and GC/MS to study the effect of halide type on organic salt degradation. No observable difference in the ¹H NMR spectra was seen between the chloride and bromide organic salts after aging at 120° C. Both samples showed signs of degradation, but the extent to which each degraded was nearly the same. The results from GC/MS, however, indicate that organic salts containing bromide anions may be more stable than those with chloride anions under these conditions. The organic salt samples with bromide anions showed a smaller number of alkylimidazole and amine alkylation degradation products than the chloride organic salts in this study.

The compounds and methods of the appended claims are not limited in scope by the specific compounds and methods described herein, which are intended as illustrations of a few aspects of the claims and any compounds and methods that are functionally equivalent are within the scope of this disclosure. Various modifications of the compounds and methods in addition to those shown and described herein are intended to fall within the scope of the appended claims. Further, while only certain representative compounds, methods, and aspects of these compounds and methods are specifically described, other compounds and methods and combinations of various features of the compounds and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

1. A composition comprising an organic salt, an amine, and water,
wherein the organic salt comprises a cation and an anion selected from the group consisting of:
i) a 2-substituted imidazolium cation and a halide anion; and
ii) a substituted imidazolium cation and a trifluoromethanesulfonate anion,
wherein water is present in an amount of about 5% to about 15% based on the weight of the composition.

2. The composition of claim 1, further comprising a compound selected from the group consisting of CO₂, SO₂, SO₃, H₂S, N₂O, NO, N₂O₃, NO₂, and N₂O₅.

3. The composition of claim 1, further comprising a compound selected from the group consisting of CO₂, SO₂, SO₃, and H₂S.

4. The composition of claim 1, further comprising CO₂.

5. The composition of claim 1, wherein water is present in an amount of about 10% based on the weight of the composition.

6. The composition of claim 1, wherein said amine is selected from the group consisting of a monoamine, diamine, polyamine, polyethylene amine, amino acid, neutral N-heterocycle, neutral N-heterocyclic-alkyl-amine, and combinations thereof

7. The composition of claim 1, wherein said amine is selected from the group consisting of monoethanolamine, N-methyl-monoethanolamine, diglycolamine, diethanolamine, diisopropanolamine, triethanolamine, methyldiethanolamine, N-methyldiethanolamine, monethanolamine, 2-amino-2-methyl-1-propanol, diglycolamine, diethanolamine, diethylenetriamine, spermidine, triethylenetetramine, spermine, and combinations thereof

8. A method of purifying a gas mixture, wherein said gas mixture comprises an acid gas, said method comprising the steps of:
providing a composition comprising an organic salt, an amine and water, wherein the organic salt comprises a cation and an anion selected from the group consisting of:
i) 2-substituted imidazolium cation and a halide anion and a; and
ii) a substituted imidazolium cation and a trifluoromethanesulfonate anion and,
wherein water is present in an amount of about 5% to about 15% based on the weight of the composition;
contacting said composition with said gas mixture, whereby said acid gas is absorbed in said composition; and
releasing said acid gas from said composition by heating said composition.

9. The method of claim 8, wherein said acid gas comprises a compound selected from the group consisting of CO₂, SO₂, SO₃, H₂S, N₂O, NO, N₂O₃, NO₂, and N₂O₅.

10. The method of claim 8, wherein said acid gas comprises CO₂, SO₂, SO₃, and H₂S.

11. The method of claim 8, wherein said acid gas comprises CO₂.

12. The method of claim 8, wherein said composition does not absorb significant amounts of water from said gas mixture.

13. The method of claim 8, wherein the percentage of said water in said composition changes less than 5% after contacting said composition with said gas mixture.

14. The method of claim 8, wherein said amine is selected from the group consisting of a monoamine, diamine, polyamine, polyethylene amine, amino acid, neutral N-heterocycle, neutral N-heterocyclic-alkyl-amine, and combinations thereof.

15. The method of claim 8, wherein said amine is selected from the group consisting of monoethanolamine, N-methyl-monoethanolamine, diglycolamine, diethanolamine, diisopropanolamine, triethanolamine, methyldiethanolamine, N-methyldiethanolamine, monethanolamine, 2-amino-2-methyl-1-propanol, diglycolamine, diethanolamine, diethylenetriamine, spermidine, triethylenetetramine, spermine, and combinations thereof.

16. The method of claim 8, wherein an adduct is formed between said amine and said acid gas and said adduct does not precipitate out of said composition.

17. The method of claim 8, wherein said percentage of said water ranges from about 5% to about 10%.

18. A composition comprising an organic salt and an amine, wherein the organic salt comprises a cation and an anion selected from the group consisting of:
i) a 2-substituted imidazolium cation and a halide anion and; and
ii) a substituted imidazolium cation and a trifluoromethanesulfonate anion,
wherein water is present in an amount of about 5% to about 15% based on the weight of the composition; and
wherein the ratio of the organic salt to the amine is from 4:1 to 1:4.
